(19) United States
(12) Patent Application Publication
(10) Pub. No.: US 2011/0081806 A1
(43) Pub. Date: Apr. 7, 2011

(54) Lamp Tube Adapter Structure for Lighting Apparatus

(76) Inventor: Li-Hua LIN, Sindian City (TW)

(21) Appl. No.: 12/181,883

(22) Filed: Jul. 29, 2008

(51) Int. Cl. H01R 13/66; H01R 27/02; H01R 13/70

(52) U.S. Cl. 439/620.21; 439/638

(57) ABSTRACT

An lamp tube adapter structure is disclosed to include a lamp tube adapter, which has two lamp socket assemblies for holding a lamp tube electrically, and two connectors for connecting the lamp socket assemblies of the lamp tube adapter to the lamp holders of a conventional lamp rack electrically for allowing adjustment of the angle of the lamp tube adapter relative to the lamp holders of the lamp rack.

### BACKGROUND OF THE INVENTION

1. Field of the Invention

The present invention relates to a lighting apparatus and more particularly to a lamp tube adapter structure for lighting apparatus, which allows installation of a relatively smaller lamp tube in an old lamp rack and also allows adjustment of the mounting angle of the new lamp tube.

2. Description of the Related Art

A conventional magnetic fluorescent lamp, as shown in FIG. 1, comprises a lamp tube 10 (T8 tube), a magnetic ballast 20 connected to one end of the lamp tube 10, and a starter 30 connected in series to the lamp tube 10.

A lighting apparatus using a T8 fluorescent lamp tube generally comprises a rack, and two lamp holders mounted in the rack at the ends to hold a T8 tube. The two lamp holders are affixed to the rack. Therefore, the distance between the two lamp holders is not adjustable to fit a different size of lamp tube, i.e., this design of lighting apparatus cannot be used with a T5 tube or any lamp tube smaller than T5 tube. For using a T5 lamp tube, a different rack shall be used. Further, when a used lighting apparatus is detached, the parts cannot be used again, and the waste parts may cause environmental protection problems. Because magnetic fluorescent lamps are widely used everywhere, disposal of waste magnetic fluorescent lamps is an important subject. Improper disposal of waste magnetic fluorescent lamps may cause severe environmental protection problems.

Further, a regular magnetic ballast for lighting apparatus can only be sued with a T8 fluorescent lamp tube. For use with a T5 lamp tube or any lamp tube smaller than the size of T5, the magnetic ballast must be changed.

### SUMMARY OF THE INVENTION

The present invention has been accomplished under the circumstances in view. It is one object of the present invention to provide a lamp tube adapter structure, which allows installation of a T5 lamp tube in a T8 lamp rack.

According to one aspect of the present invention, the lamp tube adapter structure comprises a lamp tube adapter, which has two lamp socket assemblies for holding a lamp tube electrically, and two connectors for connecting the lamp socket assemblies of the lamp tube adapter to the lamp holders of a conventional lamp rack electrically for allowing adjustment of the angle of the lamp tube adapter relative to the lamp holders of the lamp rack.

According to another aspect of the present invention, the lamp socket assemblies of the lamp tube adapter each comprise a plurality of contact holes disposed at different elevations, and the connectors each have a contact pin disposed at one side and selectively coupled to one contact hole of each of the lamp socket assemblies of the lamp tube adapter to secure the lamp tube adapter to the lamp holders of the lamp rack at one of a series of elevations.

According to another aspect of the present invention, one lamp socket assembly of the lamp tube adapter comprises a power socket for connection to power source by a power cable.

After removable of the lamp tube adapter and the connectors from the lamp holders of the lamp rack, a T8 lamp tube can be installed in the lamp holder of the lamp rack. After removable of the T8 lamp tube from the lamp holders of the lamp rack, the lamp tube adapter can be coupled to the lamp holders of the lamp rack by the connectors to hold a T5. There the invention allows the lighting apparatus to be selectively used with a T8 lamp tube or T5 lamp tube.

### BRIEF DESCRIPTION OF THE DRAWINGS

FIG. 1 is a circuit layout of a conventional fluorescent lamp.

FIG. 2 is an elevational view of a lamp tube adapter structure according to the present invention before installation in a conventional lamp rack.

FIG. 3 is another exploded view of FIG. 2.

FIG. 4 is an oblique elevation of a connector for the lamp tube adapter structure according to the present invention.

FIG. 5 is a schematic drawing showing the internal structure of the connector according to the present invention.

FIG. 6 is a circuit layout of the present invention.

FIG. 7 is an elevational view of the present invention, showing the lamp tube installed in the lamp tube adapter.

FIG. 8 is an enlarged view of a part of FIG. 7.

FIG. 9 is a schematic drawing of the present invention showing the connector coupled between the lamp tube adapter and the lamp rack and rotated.

FIG. 10 is a schematic drawing the holder frame of the lamp tube adapter turned with the connectors relative to the lamp rack according to the present invention.

FIG. 11 illustrates a power socket provided at one lamp socket of the lamp tube adapter for the connection of a power cable according to the present invention.

FIG. 12 illustrates another circuit layout of the present invention.

FIG. 13 is a schematic drawing showing the holder frame of the lamp tube adapter of the lamp tube adapter structure coupled to a mount according to the present invention.

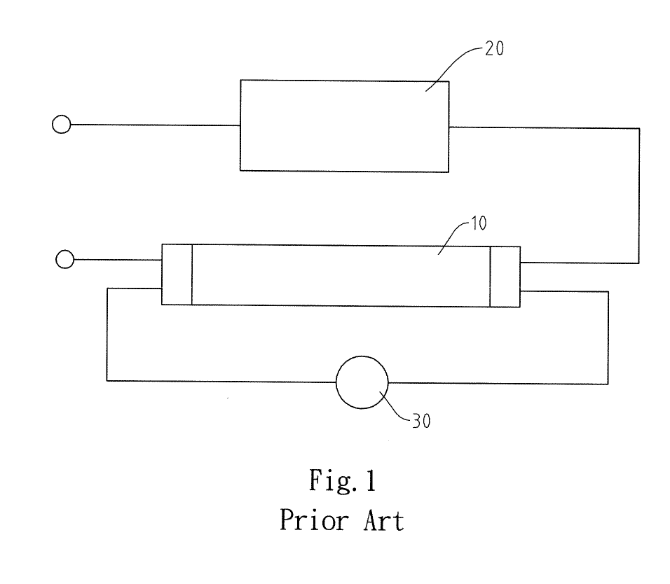

### DETAILED DESCRIPTION OF THE PREFERRED EMBODIMENT

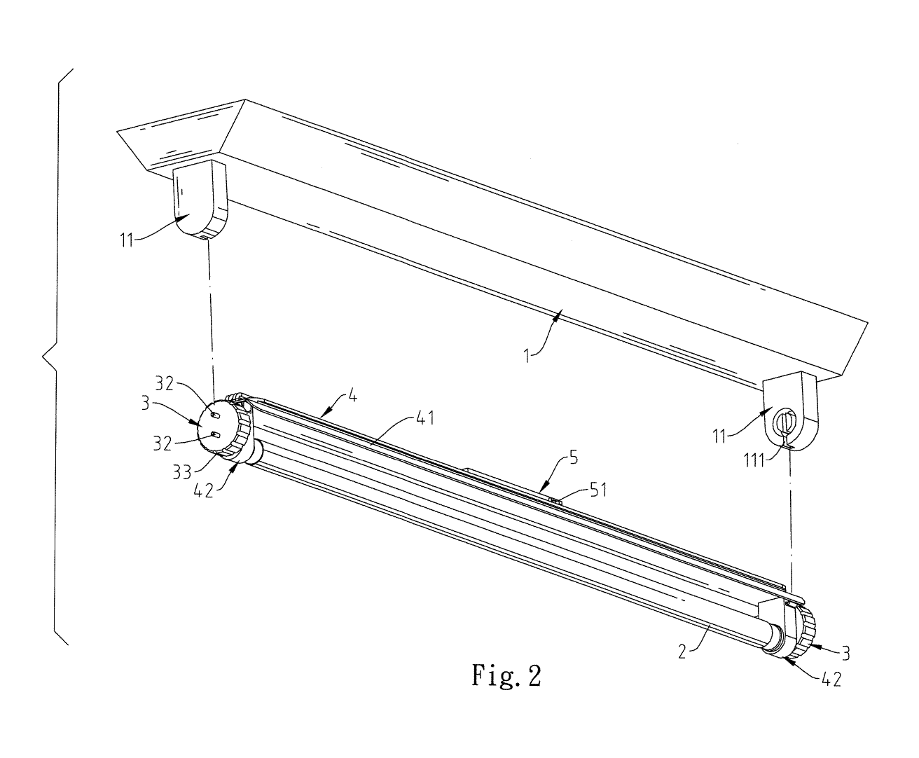

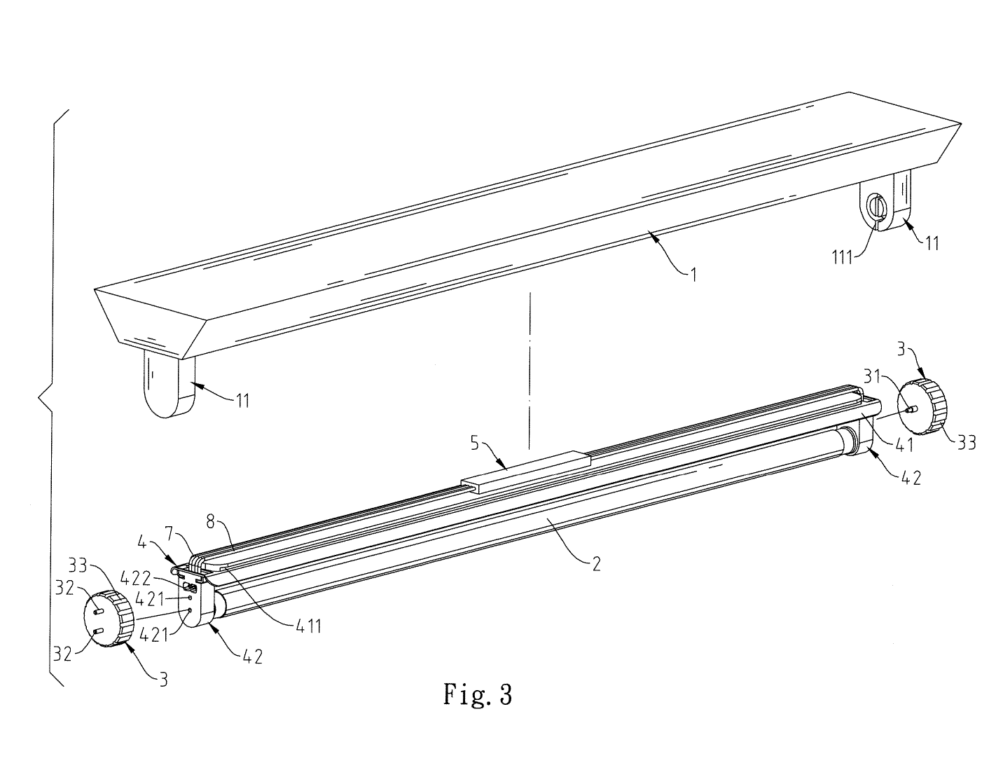

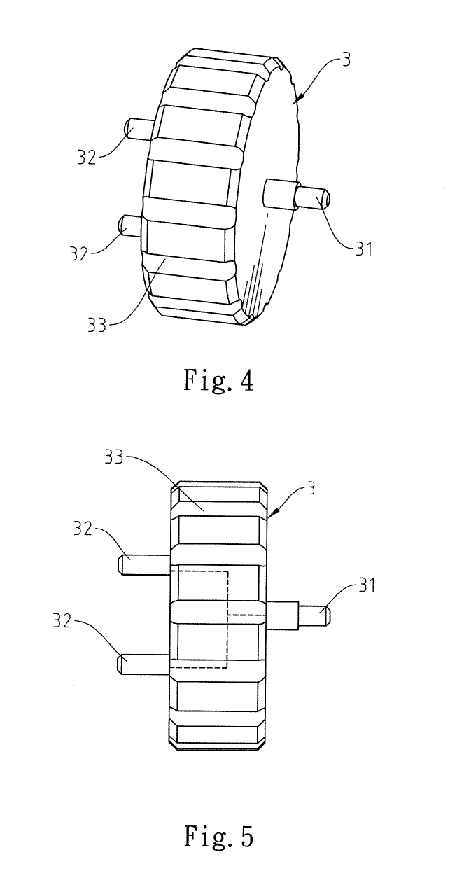

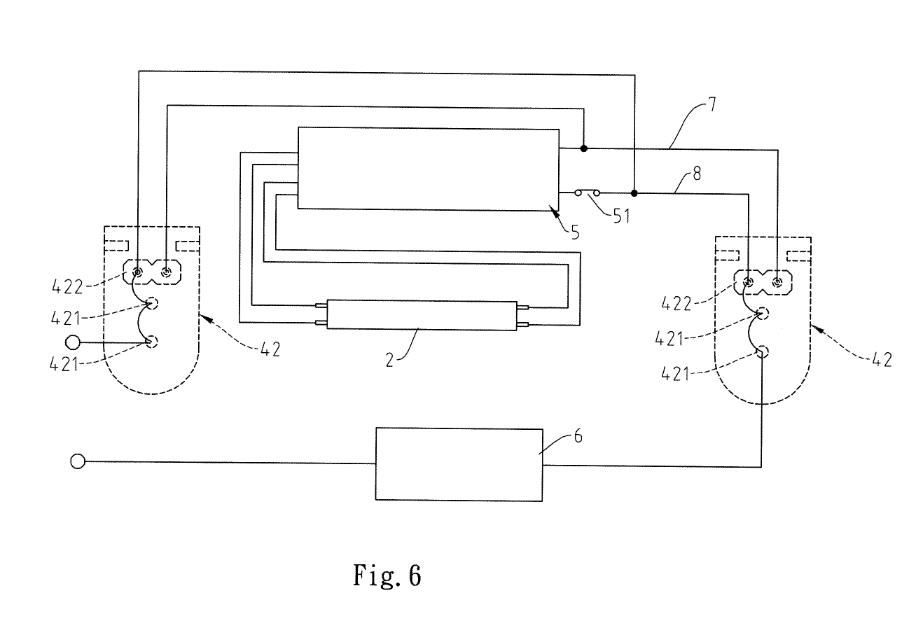

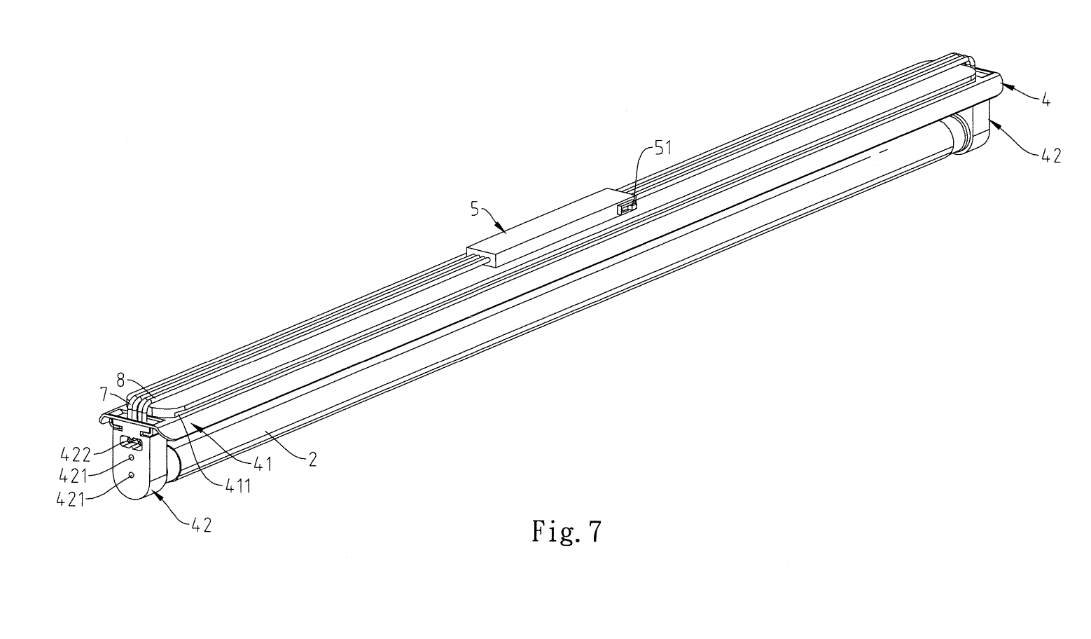

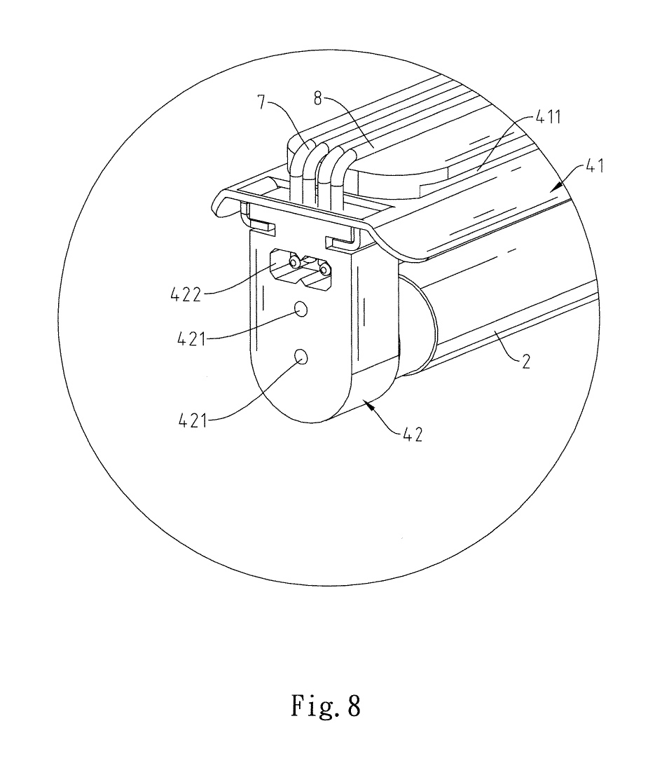

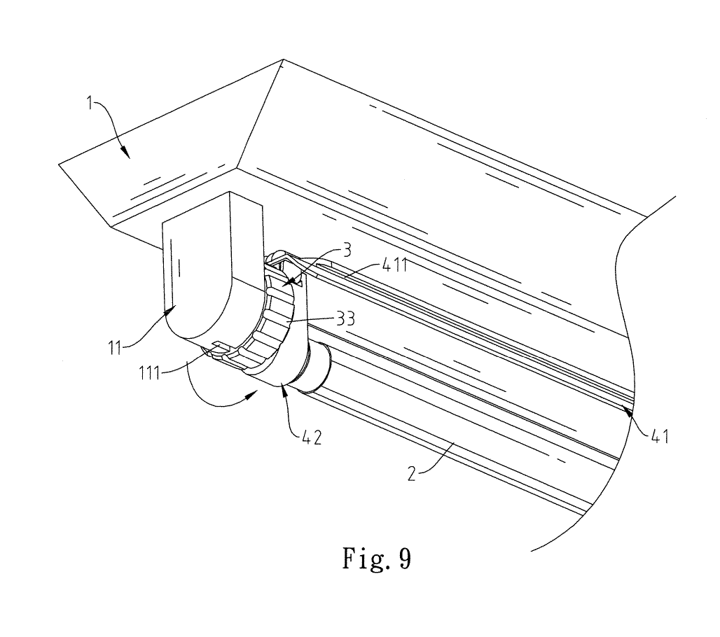

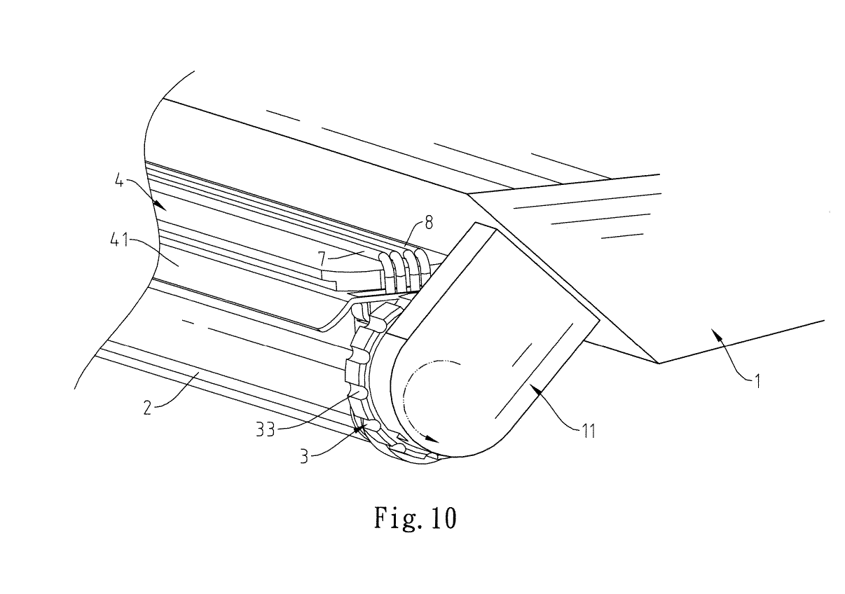

Referring to FIGS. 2˜5, the invention allows installation of a T8 lamp tube, T5 lamp tube, or lamp tube of size smaller than T5 in the lamp holders 11 of a conventional T8 type lamp rack 1.

The multiuse lighting apparatus in accordance with the present invention is comprised of a lamp rack 1, a lamp tube 2, two connectors 3, a lamp tube adapter 4, an electronic ballast 5, grounding lines 7, and power lines 8. The lamp tube 2 can be a T5 type lamp tube (a lamp tube smaller than T5). The lamp rack 1 is same as a conventional design for T8 lamp tube, comprising two lamp holders 11 fixedly provided at its one side near the two distal ends. Each lamp holder 11 has a sliding groove 111. Each connector 3 comprises a first contact pin 31 at one side and two second contact pins 32 at the opposite side. The first contact pin 31 and the second contact pins 32 are electrically connected. The second contact pins 32 of the connectors 3 are respectively coupled to the sliding grooves 111 of the lamp holders 11. The first contact pins 31 of the connectors 3 are adapted for coupling to the lamp tube adapter 4. After installation of the lamp tube 2 in the lamp tube adapter 4, the lamp tube adapter 4 can be installed in the lamp holders 11 of the lamp rack 1 with the two connectors 3. Therefore, the lamp rack 1 can selectively used to hold a T8 lamp tube or a T5 lamp tube.

Referring to FIGS. 2˜10, the lamp tube 2 is coupled to the lamp tube adapter 4, which is in turn coupled to the lamp holders 11 of the lamp rack 1 by the two connectors 3. Therefore, the lamp rack 1 can selectively used to hold a T8 lamp tube or a T5 lamp tube.

During installation, the second contact pins 32 of the connectors 3 are respectively coupled to the sliding grooves 111 of the lamp holders 11 and rotated into position. The connectors 3 each have a plurality of anti-slip ribs 33 arranged around the periphery for positive rotation with the fingers. The electronic ballast 5 is installed in the lamp tube adapter 4. The electronic ballast 5 comprises a switch 51 for switching on/off the circuit. The lamp tube adapter 4 comprises a narrow elongated holder frame 41, and two lamp socket assemblies 42 fixedly provided at the two distal ends of one side of the narrow elongated holder frame 41 for receiving the lamp tube 2. The electronic ballast 5 is electrically coupled to the two lamp socket assemblies 42 of the lamp tube adapter 4 with the grounding lines 7 and the power lines 8. After connection of the tube pins of the lamp tube 2 to the lamp socket assemblies 42 of the lamp tube adapter 4, the lamp tube 2 is electrically connected. After installation, the electronic ballast 5 has one output end connected to the lamp rack 1, and the other output end connected to the magnetic ballast 6 at the lamp rack 1. By means of a power frequency voltage from the magnetic ballast 6 at one end a high frequency voltage from the electronic ballast 5 at the other end, the lamp tube 2 is started.

The second contact pins 32 of the connectors 3 are coupled to the lamp holders 11 of the lamp rack 1. The first contact pins 31 of the connectors 3 are coupled to the lamp socket assemblies 42 of the lamp tube adapter 4. The lamp socket assemblies 42 each have a plurality of contact holes 421. The first contact pin 31 of each connector 3 can be selectively inserted into one contact hole 421 of the associating lamp socket assembly 42. Because each connector 3 is coupled to the associating lamp socket assembly 42 of the lamp tube adapter 4 with the respective first contact pin 31, the connectors 3 can be respectively rotated relative to the respective lamp socket assemblies 42 to the desired angle.

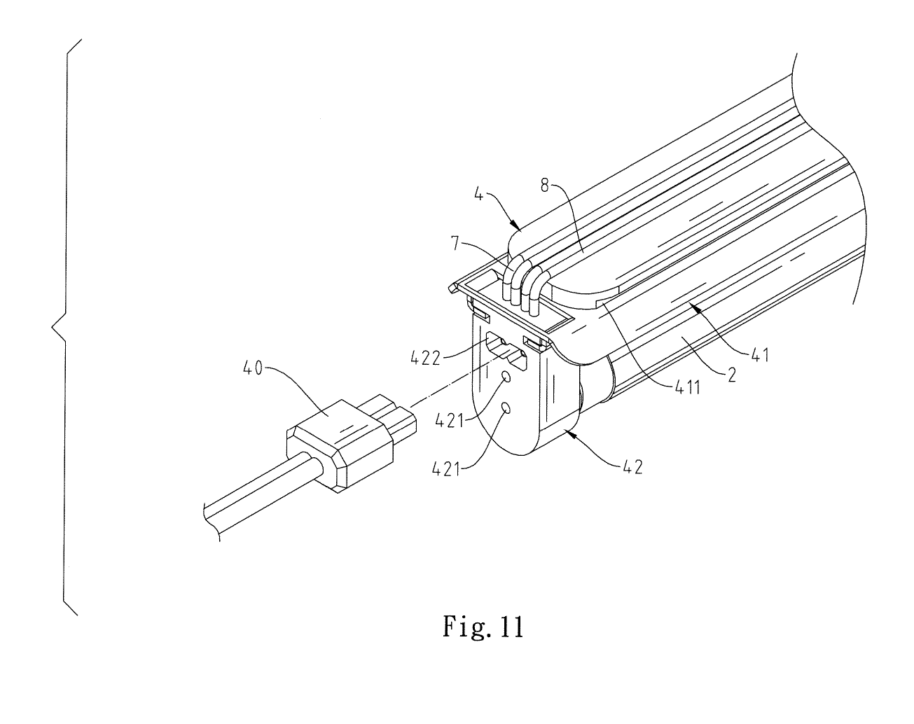

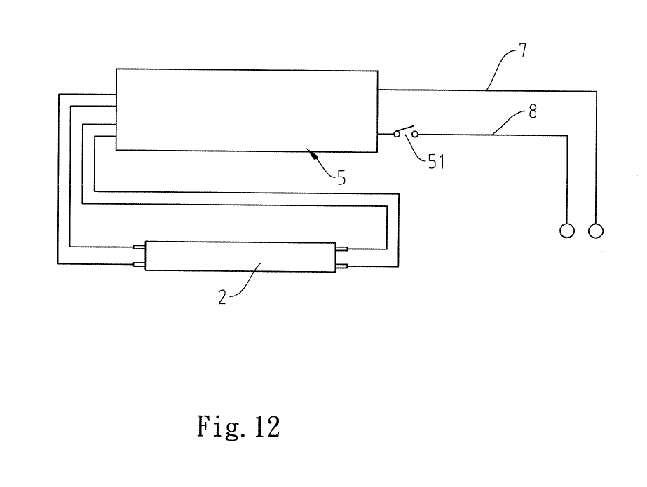

Referring to FIGS. 11 and 12, the electronic ballast 5 is installed in the lamp tube adapter 4 of the multiuse lighting apparatus. One lamp socket assembly 42 of the lamp tube adapter 4 has a power socket 422 for connection to city power source by a power cable 40 to provide power supply to the lamp tube 2.

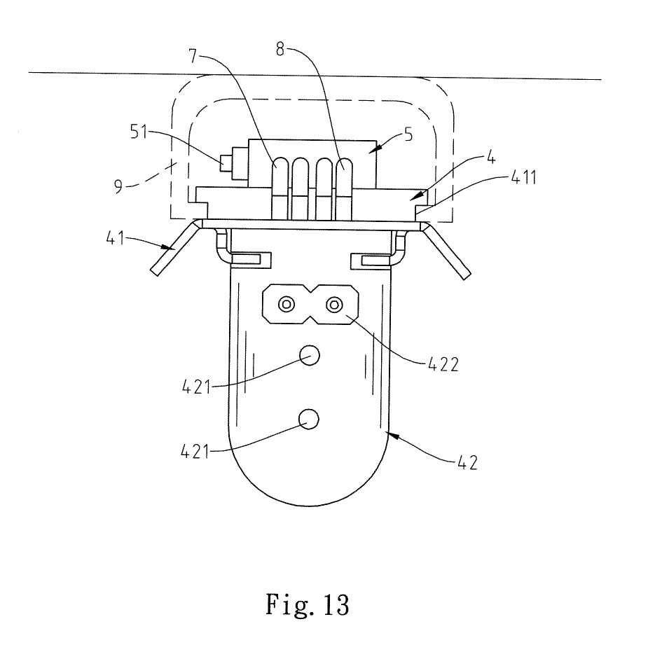

Further, the narrow elongated holder frame 41 of the lamp tube adapter 4 has coupling grooves 411 for coupled to a mount 9 (see FIG. 13).

As stated above, the invention allows the use of a conventional T8 size magnetic fluorescent lamp with a T5 lamp tube. After removal of the original T8 lamp tube and starter from the T8 size magnetic fluorescent lamp with the magnetic ballast 6 kept in the T8 size magnetic fluorescent lamp, a T5 lamp tube can be installed in the T8 size magnetic fluorescent lamp with the lamp tube adapter 4 and connectors 3 of the present invention.

Although particular embodiments of the invention have been described in detail for purposes of illustration, various modifications and enhancements may be made without departing from the spirit and scope of the invention.

What the invention claimed is:

1. A lamp tube adapter structure for installation in a lamp rack having a magnetic ballast and two lamp holders to electrically connect a lamp tube to the two lamp holders of said lamp rack, the lamp tube adapter structure comprising:
a lamp tube adapter, said lamp tube adapter comprising a holder frame, two lamp socket assemblies fixedly mounted on two distal ends of one side of said holder frame to hold a lamp tube, said lamp socket assemblies each comprising a plurality of contact holes; and
two connectors adapted to connect the lamp socket assemblies of said lamp tube adapter to the lamp holders of said lamp rack electrically, said connectors each comprising a first contact pin disposed at a first side thereof and respectively and selectively coupled to one of the contact holes of each of said lamp socket assemblies to electrically connect said lamp tube adapter to the lamp holders of said lamp tube and two second contact pins respectively coupled to the lamp holders of said lamp rack.

2. The lamp tube adapter structure as claimed in claim 1, further comprising an electronic ballast, a plurality of grounding lines, and a plurality of power lines, said grounding lines and said power lines electrically connecting said electronic ballast to said lamp socket assemblies, said electronic ballast comprising a first output end electrically connected to one lamp holder of said lamp rack and a second output end electrically connected to the magnetic ballast of said lamp rack through the other lamp holder of said lamp rack such that said magnetic ballast and said electronic ballast respectively provide a power frequency voltage and a high frequency voltage to said lamp tube to start said lamp tube.

3. The lamp tube adapter structure as claimed in claim 2, wherein said electronic ballast is installed in said lamp tube adapter.

4. The lamp tube adapter structure as claimed in claim 3, wherein said electronic ballast comprises an on/off switch.

5. The lamp tube adapter structure as claimed in claim 1, wherein said connectors each have a plurality of anti-slip ribs arranged around the periphery thereof.

6. The lamp tube adapter structure as claimed in claim 1, wherein one lamp socket assembly of said lamp tube adapter comprises a power socket for connection to power supply through a power cable.
